(19) United States
(12) Patent Application Publication
(10) Pub. No.: US 2018/0232381 A1
(43) Pub. Date: Aug. 16, 2018

(54) SYSTEM AND METHOD FOR EFFICIENT BACKUP OF COMMON APPLICATIONS

(71) Applicant: Acronis International GmbH, Schaffhausen (CH)

(72) Inventors: Alexander G Tormasov, Moscow (RU); Stanislav S. Protasov, Moscow (RU); Serguei M. Beloussov, Costa Del Sol (SG); Mark Shmulevich, Moscow (RU)

(21) Appl. No.: 15/891,480

(22) Filed: Feb. 8, 2018

Related U.S. Application Data
(60) Provisional application No. 62/458,089, filed on Feb. 13, 2017.

(51) Int. Cl. G06F 17/30; G06F 21/62; G06F 11/14

(52) U.S. Cl. CPC G06F 17/30073; G06F 21/6227; H04L 9/008; G06F 11/1469; G06F 11/1453; G06F 17/30156

(57) ABSTRACT

The present disclosure relates to systems and methods for archiving and restoring data. An exemplary method comprises receiving a request to archive, at a data center, an encrypted data object stored on a remote computing node, determining whether at least one of a copy of the encrypted data object or a similar data object exists in an archive of encrypted data objects stored at the data center, when a copy of the encrypted data object is found, generating a reference to the copy of the encrypted data object and archiving the reference in the archive as a proxy for the encrypted data object. When a similar data object is found, the method generates a reference to the similar data object, identifies information unique to the encrypted data object by comparing the encrypted data object and the similar data object; and archives both the reference to the similar data object and the unique information as a proxy for the encrypted data object.

### CROSS-REFERENCE TO RELATED APPLICATIONS

The present application claims priority to U.S. Provisional Patent Application No. 62/458,089 filed on Feb. 13, 2017, which is herein incorporated by reference in its entirety.

### FIELD OF TECHNOLOGY

The present disclosure generally relates to the field of electronic data storage, and more specifically, to systems and methods for archiving and restoring data of common applications that utilize deduplication techniques to reduce the amount of storage necessary and utilization of network resources.

### BACKGROUND

As the number of applications and services provided over the Internet continues to increase, the amount of electronic content, applications and services used by individuals, enterprises, and the like also continues to rise significantly. This increased reliance on electronic content has spurred the development of backup solutions to archive user and enterprise data. These solutions currently include a variety of local storage options (e.g., use of external hard drives) and remote storage options (e.g., data centers) which may be privately owned or operated by a third party vendor.

While local storage remains a viable option for short-term backups and small volumes of non-essential data, in recent years remote storage has become increasingly prevalent among enterprise-level users. This trend is fueled in part by the increasingly ubiquitous nature of internet access and the fact that in the modern global economy, end users (e.g., employees) may be located in tens or hundreds of different locations. Similarly, mid-sized and large enterprises may maintain multiple data centers around the world.

Accordingly, systems have been developed for archiving or synchronizing data between remote locations (e.g., between an end user and a data center or between data centers). However, the costs of data synchronization and distributed storage increase proportionally with the amount of data being stored and the overhead required for transmission. Bandwidth limitations provide an additional physical bottleneck, as infrastructure may not be available to provide rapid transmission of data between locations, such as between geographically distant locations or on a local intranet that simply lacks high-speed transmission capabilities. Similarly, unreliable network connections can disrupt the transmission of large files, necessitating retransmission and a concomitant increase in cost.

In view of these limitations, synchronization of large files or large collections of files (e.g., terabytes of data) can be especially cost prohibitive for organizations and enterprises with a large, distributed network of users and/or resources. In order to address bandwidth limitations, enterprises may opt to maintain multiple copies of the same data, e.g., by caching content locally or using multiple data centers, so that a local or nearby copy is available for end users at various locations. However, the use of such policies creates security concerns, as the likelihood of data being inadvertently or inappropriately accessed internally, or stolen by a third party, increases directly with the number of copies in existence.

As a result, there remains a need for more efficient, secure and cost-saving techniques for storing and synchronizing data content, especially between a large number of users and/or multiple data centers.

### SUMMARY

The present disclosure provides an effective solution to the foregoing problems by using deduplication techniques to reduce both the amount of data stored by remote data centers and reliance on network resources required to perform backup and restore operations of common applications. Other advances and contributions to the current state of the art will be further apparent to one of ordinary skill in view of the following description. In particular, the disclosure provides various systems, methods and computer program products for performing backup and restoration of data, synchronization and other related file transfer operations as described in detail herein.

In a first exemplary aspect, a method is disclosed for archiving electronic data, comprising: receiving, by a data center, a request to archive an encrypted data object stored on a remote computing node; determining, by the data center, whether at least one of a copy of the encrypted data object or a similar data object exists in an archive of encrypted data objects stored at the data center; when a copy of the encrypted data object is found, generating a reference to the copy of the encrypted data object and archiving the reference as a proxy for the encrypted data object; when a similar data object is found, generating a reference to the similar data object; identifying information unique to the encrypted data object by comparing the encrypted data object and the similar data object; and archiving the reference to the similar data object and the unique information as a proxy for the encrypted data object.

In some exemplary aspects, determining whether the at least one of a copy of the encrypted data object or a similar data object exists comprises: decrypting, at least a portion of the encrypted data object; and decrypting, at least a portion of the one or more data objects in the archive of encrypted data objects; and comparing the decrypted portion of the encrypted data object and the decrypted portion of the or more data objects in the archive of encrypted data objects.

In some exemplary aspects, the encrypted data object and the one or more data objects in the archive of encrypted data objects are encrypted using a homomorphic encryption algorithm.

In some exemplary aspects, comparing the encrypted data object and the similar data object comprises comparing at least one of the following parameters: a) a file name; b) a file size; c) a version; d) a configuration; or e) metadata associated with a creation date and/or last modification date.

In some exemplary aspects, the archived unique information comprises one or more of the following: a) at least one file or a portion thereof; b) at least one registry entry; and/or c) data associated with a user-defined or preset configuration.

In some exemplary aspects, the encrypted data object comprises one or more of the following: a) an application; b) a database; c) at least one file or a portion thereof; and/or d) an operating system component.

In some exemplary aspects, comparing the encrypted data object and the similar data object is performed by a client application executed on the remote computing node and the unique information is transmitted by the client application to the data center.

In some exemplary aspects, the archived reference to the copy of the encrypted data object or the similar data object is a symbolic link or a hard link.

In some exemplary aspects, the encrypted data object is not decrypted at any point during the archiving process.

In some exemplary aspects, comparing the encrypted data object and the similar data object comprises performing a binary-level comparison.

In some exemplary aspects, the encrypted data object comprises an application and the similar data object comprises a different version of the application.

In some exemplary aspects, the archived unique information comprises at least one file, or a portion thereof, unique to the encrypted data object and omitted from the the similar data object.

In some exemplary aspects, the reference to the similar data object comprises a hard link or a symbolic link.

In another exemplary aspect, a system for archiving electronic data is provided, comprising: an electronic memory; and a processor configured to: receive, by a data center, a request to archive an encrypted data object stored on a remote computing node; determine, by the data center, whether at least one of a copy of the encrypted data object or a similar data object exists in an archive of encrypted data objects stored at the data center; when a copy of the encrypted data object is found, generate a reference to the copy of the encrypted data object and archive the reference as a proxy for the encrypted data object; when a similar data object is found, generate a reference to the similar data object; identify information unique to the encrypted data object by comparing the encrypted data object and the similar data object; and archive the reference to the similar data object and the unique information as a proxy for the encrypted data object.

In some exemplary aspects, the processor is further configured to perform any of the methods disclosed herein.

In another exemplary aspect a non-transitory computer readable medium storing computer executable instructions for archiving electronic data is provided, including instructions for: receiving, by a data center, a request to archive an encrypted data object stored on a remote computing node; determining, by the data center, whether at least one of a copy of the encrypted data object or a similar data object exists in an archive of encrypted data objects stored at the data center; when a copy of the encrypted data object is found, generating a reference to the copy of the encrypted data object and archiving the reference as a proxy for the encrypted data object; when a similar data object is found, generating a reference to the similar data object; identifying information unique to the encrypted data object by comparing the encrypted data object and the similar data object; and archiving the reference to the similar data object and the unique information as a proxy for the encrypted data object.

In some exemplary aspects, the non-transitory computer readable medium further comprises instructions for performing any of the methods disclosed herein.

The above simplified summary of an exemplary aspect serves to provide a basic understanding of the disclosure. This summary is not an extensive overview of all contemplated aspects, and is intended to neither identify key or critical elements of all aspects nor delineate the scope of any or all aspects of the disclosure. Its sole purpose is to present one or more aspects in a simplified form as a prelude to the more detailed description of the disclosure that follows. To the accomplishment of the foregoing, the one or more aspects of the disclosure include the features described and particularly pointed out in the claims. Moreover, it is understood that the individual limitations of elements of any of the disclosed methods, systems and software products may be combined to generate still further aspects without departing from the spirit of the present disclosure and the inventive concepts described herein.

### BRIEF DESCRIPTION OF THE DRAWINGS

The accompanying drawings, which are incorporated into and constitute a part of this specification, illustrate one or more exemplary aspects of the present disclosure and, together with the detailed description, serve to explain their principles and implementations.

FIG. 1 is a block diagram illustrating a system for archiving electronic data according to an exemplary aspect.

FIG. 2 is a flowchart illustrating an exemplary aspect of a method for archiving electronic data according to the present disclosure.

FIG. 3 illustrates an example of a general-purpose computer system on which the disclosed systems and methods (e.g., the exemplary aspects illustrated by FIGS. 1 and 2) can be implemented.

FIG. 4 is a flowchart illustrating an exemplary aspect of a method for upgrading a data object according to the present disclosure.

FIG. 5 is a flowchart illustrating another exemplary aspect of a method for upgrading a data object according to the present disclosure

### DETAILED DESCRIPTION

Various aspects are now described with reference to the drawings, wherein like reference numerals are used to refer to like elements throughout. In the following description, for purposes of explanation, numerous specific details are set forth in order to promote a thorough understanding of one or more aspects. It may be evident in some or all instances, however, that any aspect described below can be practiced without adopting the specific design details described below. In other instances, well-known structures and devices are shown in block diagram form in order to facilitate description of one or more aspects. The following presents a simplified summary of one or more aspects in order to provide a basic understanding of the aspects. This summary is not an extensive overview of all contemplated aspects, and is not intended to identify key or critical elements of all aspects nor delineate the scope of any or all aspects.

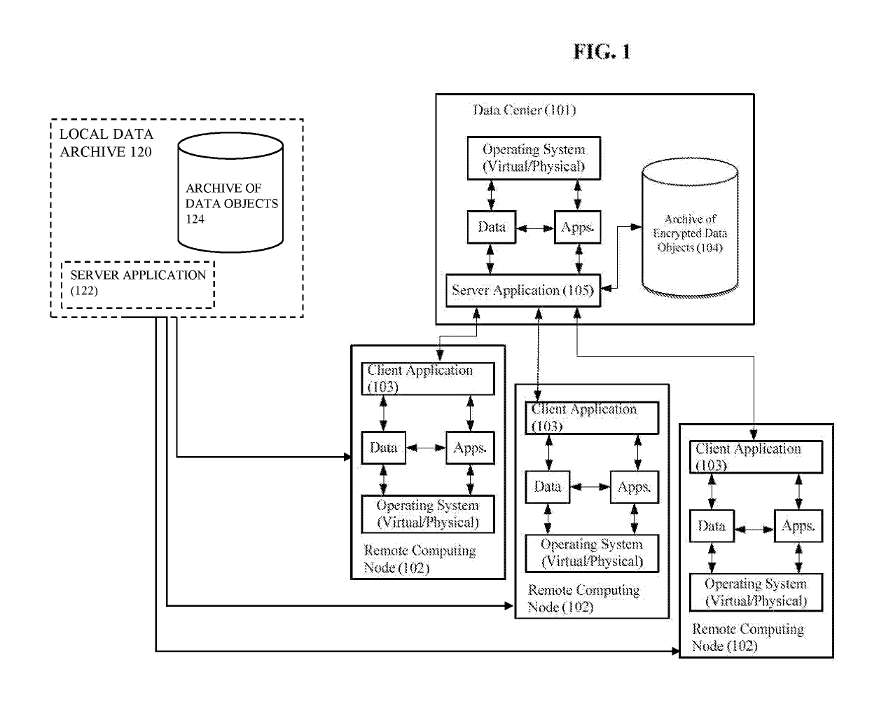

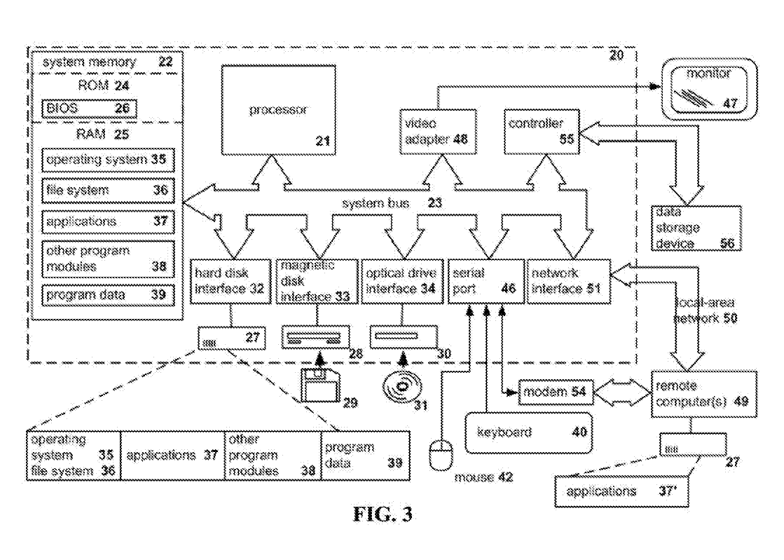

As described herein, methods and systems are disclosed for archiving electronic data, such as between a computing node (102) and a remote data center (101). The computing node (102) may be any type of computing device, such as a laptop, a desktop, a personal digital assistant (PDA), a tablet, a mobile phone and the like. The specific details of an exemplary computer that may function as a computing node (102) will be described below with respect to FIG. 3. However, as generally shown in FIG. 1, each computing node (102) includes input/output requests, stored data, and multiple software applications.

As will be appreciated herein, these methods and systems provide an efficient mechanism for securely archiving, transmitting and/or synchronizing electronic data between devices at multiple locations, which can allow individuals and enterprises to reduce, at least to some extent, data transmission costs and potential security concerns. In some exemplary aspects, as discussed below, such methods and systems are particularly useful for archiving data which may be encrypted, and in some exemplary aspects the data remains encrypted throughout the archiving process (e.g., implementing end-to-end encryption). In still further exemplary aspects, it will be apparent that the term computing node is widely understood as encompassing desktop computer, servers, mobile phones, data centers and any other devices capable of implementing the disclosed methods.

In general, mid-sized to large companies and organizations maintain network infrastructure to provide users with Internet access and/or with access to a local intranet. An intranet can be structured as a physically isolated local network, or logically, using encrypted communication channels (e.g. a VPN connection) that are connected via the Internet. Large companies and organizations also typically maintain network-accessible data storage facilities (e.g., data centers) that can receive and archive data transmitted from remote users. Data centers may also archive or synchronize data with end users, ensuring for example, that users receive the most recent version of a given file or other electronic data.

In some instances, data centers may be operated by third party vendors that house storage for a variety of corporate and/or individual clients. It is not uncommon for a data center to contain multiple versions of the same data objects (e.g., files, applications, or other data structures). For example, a large number of corporate users may have copies of the same set of office productivity applications (e.g., Microsoft Office) installed on their desktops, which may be selected for archiving at the same data center. The data center may be configured to allocate storage space for each copy of the application. However, this configuration is non-ideal because numerous redundant copies of the same set of office productivity applications (also referred herein as “the common applications”) will then be stored at the data center, increasing storage space requirements.

A similar problem occurs when archiving different versions of the same application (also referred herein as “the common applications”); in that case, a substantial portion of the set of files associated with a given application may be identical between different versions, resulting in the archived versions being partially redundant. In this scenario, the amount of storage space required is similarly excessive, though to a lesser extent than when identical copies are archived. Furthermore, the transmission of duplicative (or substantially duplicative) applications and other data objects to a data center wastes network resources, which may amount to substantial costs when considered as an aggregate expense for a large corporation.

The present application addresses the above-identified concerns by providing archiving solutions for the common applications that utilize a reduced amount of storage space and network resources compared to methods previously known in the art. In view of the existing computing and networking infrastructure described above, FIG. 1 illustrates a block diagram of a system for archiving electronic data according to an exemplary aspect. As will be described in detail below, the systems and methods disclosed herein employ deduplication to efficiently archive, restore, and/or synchronize electronic data while reducing or eliminating redundancy.

As generally shown, a system according to the disclosure may include one or more remote computing nodes (102) connected by a network to at least one data center (101). A client application (103) may be installed on the remote computing nodes (102) which is capable of communicating with a server application (105) installed at the data center (101). For example, the client application (105) may be configured to manage data objects (e.g., files, applications, and other data structures) on the remote computing node (102) and to select and transmit data objects to the data center (101) for archiving. In some exemplary aspects, the client application (103) may receive instructions from the server application (105) related to the selection of data objections for archiving. For example, the server application (105) may transmit policy updates or instructions to archive specific data objections or classes of data objects.

Data objects selected for archiving may be compared against an archive of data objects stored at the data center (101). In some aspects, the data center stores an archive of encrypted data objects (104) (e.g., which may be encrypted using a homomorphic algorithm or other cryptographic techniques). In some aspects, the present system implements end-to-end encryption such that the data objects stored on the remote computing nodes (102) and in the archive of data objects at the data center (101) are subject to encryption. In exemplary aspects of this type, methods according to the present disclosure may be modified so that the data objects are never decrypted at any stage of the archiving and/or restoration process (e.g., using homomorphic encryption which allows for operations with encrypted data without knowledge of the contents; operations may include data duplication or the like). In other aspects, the data objects may be wholly or partially decrypted during the archiving and/or restoration process. For simplicity, this disclosure will generally refer to the archive of encrypted data objects (104). However, it is understood that it is not a strict requirement and that the data center (101) may archive encrypted or unencrypted data objects, as preferred for a given implementation.

Data objects within the scope of this disclosure may include any data structure that may be stored in the memory of a computer. This includes, files or portions thereof, data structures, applications, operating systems and components thereof, containers and virtual machines. Data objects further include compressed or collective data structures such as zip files which may contain a set of files or other data objects. When a data object has been selected for archiving, the client application (103) may communicate with the server application (105) to determine whether a copy of the data object or a similar data object has previously been archived at the data center (101). This determination may be made by the client application (103) or the server application (105). In one aspect, “similar data object” refers to data objects which differ by content, but are of the same data type. For example, similar data objects may be one or more of the same file type, the same data category, they may both contain links to pictures, media, textual information or the like.

For example, the client application (103) may receive information from the server application (105) and make a determination based on this information, or the client application (103) may transmit information to the server application (105) so that the decision can be made at the data center (101). Regardless of the specific implementation details, this determination will require a comparison of information or parameters associated with the data object against information or parameters associated with data objects in the archive of data objects. For example, in some aspects this may include a comparison of a hash or signature associated with each of the respective data objects. The determination may also be based on a comparison of one or more of a file name, file size, version, configuration or any other metadata associated with the data objects. In this aspect, the determination of similarity between two objects can be performed on two encrypted objects without decryption because the encryption (e.g., homomorphic encryption) used allows for file or data block comparisons. In another aspect, hashes of the files taken before encryption can be compared. In yet another aspect, additional metadata can be stored outside of the encrypted content in order to aid the determination of similarity.

If the comparison reveals that two data objects are identical (e.g., detecting a copy of the data objects selected for archiving exists in the data center's archive of encrypted data objects (104), it is unnecessary for the data object to be transmitted from the computing node (102) to the data center (101). In this case, a reference may be generated as a proxy for the data object wherein the reference is linked to or otherwise identifies the existence of a previously archived copy of the data object. For example, a reference may comprise information containing at least one of a data object's file (or application) name, version or configuration. Such references may be structured as a hard link or a symbolic (soft) link. A hard link is a directory entry that associates a name with a file on a file system, while a symbolic link is any file that contains a reference to another file or directory in the form of an absolute or relative path and that affects pathname resolution.

References may be generated by the client application (103) or the server application (105). For example, if the comparison is performed by the client application (103) then the client application (103) may then transmit the reference or information ascribing the reference to the data server application (105) so that the reference can be accounted for in the archive of encrypted data objects (104). In one aspect, the reference may be a pointer to the location of the data object in the archive of encrypted data objects 104, taking the form of a link that can be followed. In another aspect, the reference is a hash or number that identifies a particular data object among the encrypted data objects 104. In one aspect, the number (reference number) may be an address such as an offset, data location address (e.g. URL), server IP address, or the like. Alternatively, in some aspects the comparison may be performed at the data center (101) whereby the server application (105) may generate the reference. The use of references as proxies for duplicate data objects reduces storage requirements and utilization of network resources as it obviates the need for a redundant copy of a previously archived data object to be transmitted to the data center (101).

In some exemplary aspects, the comparison may determine whether a similar data object exists in the archive of encrypted data objects (104). This process may compare any of the hashes/signatures, parameters, or metadata identified above in the context of comparisons directed to finding copies of the data object selected for archiving. In some exemplary aspects, such methods may utilize algorithms suitable for identifying similar files or data (e.g., fuzzy hashes). However, in many instances a comparison of file name and version parameters may suffice to rapidly identify the existence of similar previously archived data objects.

For example, if the data object selected for archiving is an application, a search for archived applications having the same name but a different version number will quickly identify similar applications in many situations. Once a similar data object is identified, the client application (102) or server application (105) performing the comparison may proceed to identify unique information associated with the data object selected for archiving. For example, assuming again that a data object selected for archiving is an application, if a previous version of the same application is found to exist in the archive unique information may include a determination of files (or other data) associated with the newer version of the application. The calculation or identification of unique information may take place at the file level. However, in many exemplary aspects these process may be implemented at a finer level (e.g., in order to identify changes at the binary level).

Unique information, in a general sense, may include any differences identified between the data object selected for archiving and the previously archived data object. This includes files present in the data objects selected for archiving but absent in the archived data object, as well as binary-level changes. If a similar data object exists in the archive and it is possible to identify the information unique to the data object selected for archiving, a proxy for the data object to be archived can be created by generating a reference to the previously archived data object and also archiving the unique information as a new data object associated with the data object selected for archiving. With this reference, and accounting for the unique information, the data center (101) can regenerate the new data object by following the reference to the previously archived data object and modifying this archived data object to account for the unique information associated with the new data object.

For example, returning to the hypothetical wherein a previous version of an application has already been archived, a reference to the previous version would be created and an identification of all changes between the two versions would be recorded. With this information, the data center (101) can essentially patch the previous version of the application to regenerate the newer version of the application. As a result, the data center (101) is only required to allocate storage space for the older version of the application and the unique information, which together are likely to amount to less space than would be required to store full copies of both a previous and newer version of the same application.

As noted herein, data objects used by the present methods may be encrypted. The specific algorithms for encrypting the computer data objects generally comprise methods known in the art for securely protecting electronic data. It should also be appreciated that while computing nodes (102) and data center (101) are generally described as forming an online/remote file storage service (e.g., a cloud computing service), these components can be incorporated into a local area network or the like as should be appreciated to those skilled in the art. It is contemplated that in some aspects, the computing nodes (102) and data center (101) described above are located within a single intranet.

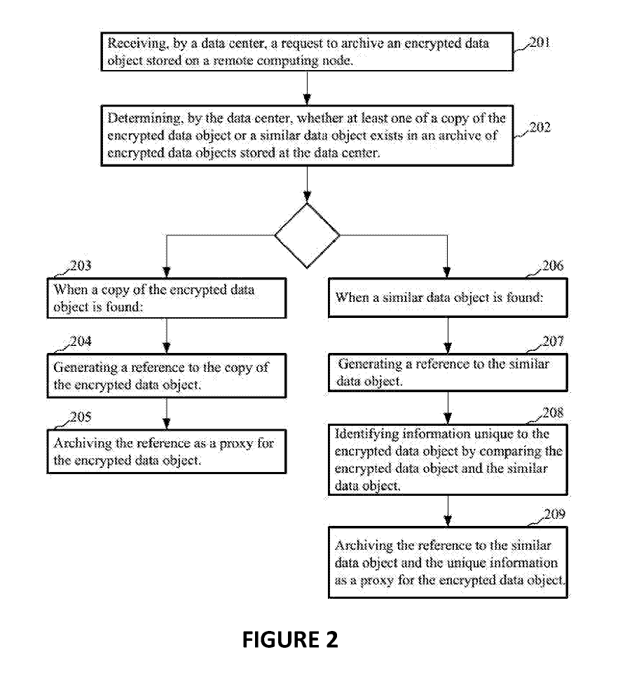

FIG. 2 illustrates a method according to one exemplary aspect of the disclosure. In a first step, a request to archive an encrypted data object stored on a remote computing node may be received by a data center (201). The data center then determines whether at least one of a copy of the encrypted data object or a similar data object exists in an archive of encrypted data objects stored at the data center (202). At this stage, when a copy of the encrypted data object is found (203), a reference to the copy of the encrypted data object is generated and archived as a proxy for the encrypted data object (204, 205). Alternatively, when a similar data object is found (206), a reference to the similar data object is generated and information unique to the encrypted data object is identified by comparing the encrypted data object and the similar data object (207, 208). Finally, the reference to the similar data object and the unique information are archived as a proxy for the encrypted data object (209).

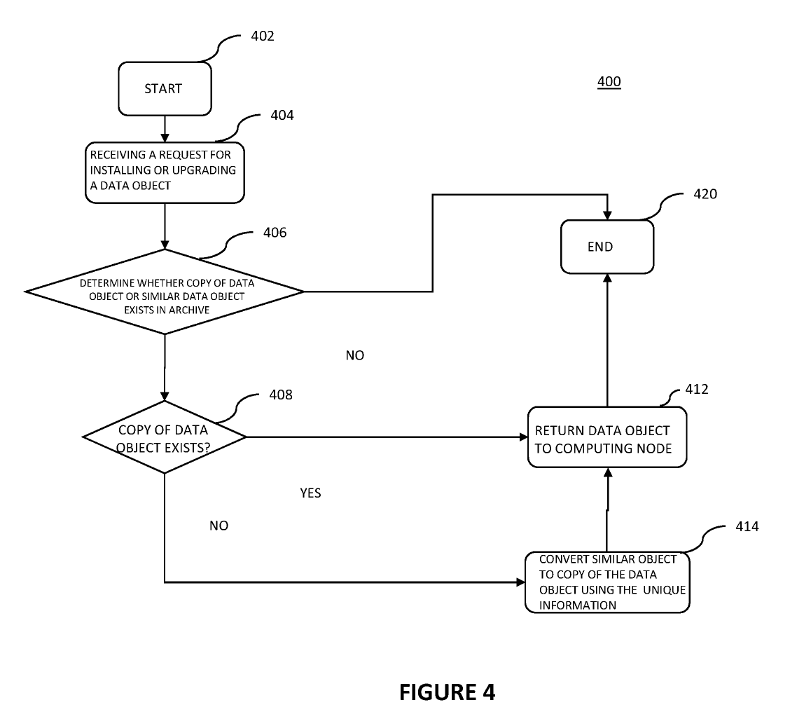

The general method of this exemplary aspect may be modified to suit the needs of a given implementation. For example, the preceding description has focused on methods of archiving data objects according to the present disclosure. However, aspects of the present systems and methods may also be used to efficiently restore data objects on a remote computing node (102) using the archived copies of data objects and the unique information stored at a data center (101) as shown by method 400 in FIG. 4. For example, a computing node (102) may need to install a data object (e.g., an application). The method 400 starts at 402. The client application (102) may communicate a request to the server application (105) to determine whether the requested data object has been archived at the data center (101) at 404. Upon receipt of this request, the server application (105) may perform a comparison using any of the methods and parameters discussed above to determine whether a copy of the data object or a similar data object exists in the archive of encrypted data objects (104) at 406. If a copy of the data objects is found at 408, it may be transmitted to the client application (103) to be installed on the computing node (103) at 412.

Alternatively, if only a similar data object is found, the server application (105) may be configured to modify the similar data object using archived unique information associated with the desired data object to convert the similar data object into the requested version of the data object at 414. At that stage, the converted data object may be transmitted to the client application (103) to be installed on the computing node at 412. The method terminates at 420.

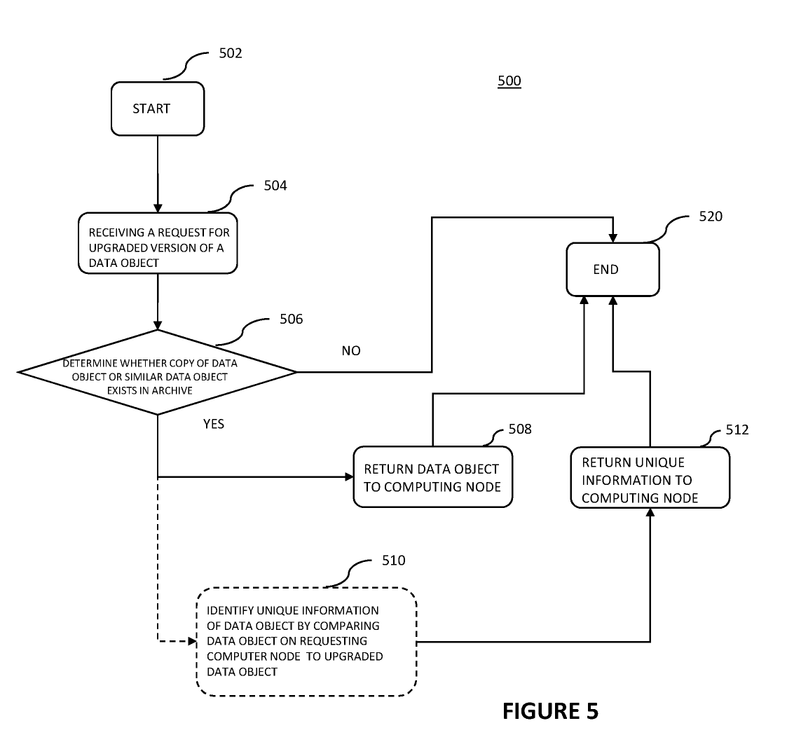

A similar process may be implemented to upgrade a data object stored on a computing node (102) as shown by method 500 in FIG. 5. A client application (103) may transmit a request to the server application center (105) requesting the upgraded version of the data object at 504. Upon receipt of this request, the server application (105) may perform a comparison using any of the methods and parameters discussed above to determine whether a copy of the upgraded data object or a similar data object exists in the archive of encrypted data objects (104) at 506. If the upgraded version of the data object has been archived, the server application (105) may transmit it to the client application (103) at 508. Alternatively, the server application (105) may compare the current version of the data object installed on the computing node (102) against the upgraded data object that has been requested in order to identify information unique to the upgraded data object at 510. The unique information may then be transmitted to the client application (103) and used to modify the currently installed version of the data object to the upgraded version at 512. The method terminates at 520.

In some instances, a user may desire to install or upgrade a data object that has a base version available from a third party (e.g., from a third party app store). In some exemplary aspects, systems and methods according to the present disclosure may be configured so that the client application (103) requests a copy of the base version of the requested data object from the third party and then performs an upgrade process according to the preceding paragraph and FIGS. 4-5 (e.g., receiving the unique information necessary to upgrade the base version to the desired version from the data center (101)). In some aspects, such methods may reduce usage of network resources and bandwidth at the data center (101) by diverting the download of the base version of the data object so that it is downloaded from the third party's servers, thereby increasing the efficiency of computing operations of the data center 101.

In some exemplary aspects, upgrading a data object comprises restoring previously archived user or preset settings, configurations, data or parameters from the data center (101). In still further exemplary aspects, the restoration or upgrading process can be configured to execute periodically or based upon user input or a preset trigger. The restoration or upgrading processes described herein may be particularly useful for upgrading data objects installed on mobile phones or mobile devices (e.g., a plurality of mobile devices provided by a large corporate entity to employees). A client application (103) installed on said mobile devices may request base versions of necessary data objects (e.g., applications) from a third party and then direct upgrade requests to a server application (105) located at a corporate-owned or associated data center (101). Such methods should expedite the delivery of necessary data objects to the mobile devices while minimizing use of data center (101) resources.

In some exemplary aspects, the client application (103) may be further configured to identify and/or catalog data objects found on a computing node (102) and to report newly-identified data objects to the server application (105) so that such applications can be archived at the data center (101). For example, in some exemplary aspects the client application (103) may identify and report any new applications found on the computing node (102). The server application (105) may respond, indicating that a copy or similar version of the application has not been archived. The client application (103) may then transmit a copy of the newly-identified application to the data center (101) to be included in the archive. Such methods may be used to efficiently catalog data objects (particularly applications) so that they may be deployed when necessary to other computing nodes (102).

The present systems and methods can further be modified to include local storage components. For example, a local data archive 120 (e.g., a server connected via a local area network, intranet, or other close-range or private network) may be provided, wherein the local data archive executes a server application (122) and the local data archive contains an archive 124 of base versions of various data objects that can be distributed to client applications (103) operating on one or more local computing nodes (102). In some exemplary aspects, the local data archive 120 may be configured to perform substantially the same function as the data center (101).

In other exemplary aspects, the local data archive 120 may be further configured such that references to upgraded versions of the locally archived data objects are available in the archive of data objects 124 in the local data archive. The server application (122) running on the local data archive 120 may utilize these links to direct requests for upgrades to remote data centers (101) such as cloud-based data centers which store the unique information necessary to modify the base version to the upgraded version. Implementations that follow this model therefore use the local data archive 120 for the initial installation of a data object (typically a large transfer) and one or more remote data centers (101) for upgrade requests which typically require less utilization of network resources when the present methods are employed.

In further exemplary aspects, methods and systems according to the present disclosure can be modified to utilize multiple data centers (101). For example, a client application (103) running on a computing node (102) may be configured to query multiple data centers (101). In some exemplary aspects, the query may be directed to one or more data centers (101) based upon the type of data object requested, geographic or network parameters, a preference list, or security parameters. Moreover, in some exemplary aspects the present methods may be implemented between data centers (101) instead of between a data center (101) and a computing node (102). Such systems and methods may be desirable when additional redundancy is required (e.g., to maintain multiple backup data centers).

Finally, FIG. 3 illustrates an example of a general-purpose computer system (which may be a personal computer or a server) on which the disclosed systems and method can be implemented according to an example aspect. It should be appreciated that the detailed general-purpose computer system can correspond to the data center or remote computing node 102 described above with respect to FIG. 1.

As shown in FIG. 3, the computer system 20 includes a central processing unit 21, a system memory 22 and a system bus 23 connecting the various system components, including the memory associated with the central processing unit 21. The system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20.

The present disclosure provides the implementation of a system that uses a hard disk 27, a removable magnetic disk 29 and a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, and so on. Such input devices usually plug into the computer system 20 through a serial port 46, which in turn is connected to the system bus, but they can be connected in other ways, for example, with the aid of a parallel port, a game port or a universal serial bus (USB). A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to operate within a network environment, using a network connection to one or more remote computers 49. The remote computer (or computers) 49 are also personal computers or servers having the majority or all of the aforementioned elements in describing the nature of a personal computer 20, as shown in FIG. 3. Other devices can also be present in the computer network, such as routers, network stations, peer devices or other network nodes.

Network connections can form a local-area computer network (LAN) 50, such as a wired and/or wireless network, and a wide-area computer network (WAN). Such networks are used in corporate computer networks and internal company networks, and they generally have access to the Internet. In LAN or WAN networks, the personal computer 20 is connected to the local-area network 50 across a network adapter or network interface 91. When networks are used, the personal computer 20 can employ a modem 54 or other modules for providing communications with a wide-area computer network such as the Internet. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted as by one of ordinary skill in the art in light of the teachings and guidance presented herein. Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for archiving electronic data, comprising:
receiving, by a hardware processor, a request to archive, at a data center, an encrypted data object stored on a remote computing node;
determining, by the hardware processor, whether at least one of a copy of the encrypted data object or a similar data object exists in an archive of encrypted data objects stored at the data center;
when a copy of the encrypted data object is found, generating a reference, by the hardware processor, to the copy of the encrypted data object and archiving the reference in the archive as a proxy for the encrypted data object; and
when a similar data object is found,
generating a reference, by the hardware processor, to the similar data object;
identifying, by the hardware processor, information unique to the encrypted data object by comparing the encrypted data object and the similar data object; and
archiving both the reference to the similar data object and the unique information as a proxy for the encrypted data object.

2. The method of claim 1, wherein determining whether the at least one of a copy of the encrypted data object or a similar data object exists comprises:
decrypting, at least a portion of the encrypted data object; and
decrypting, at least a portion of the one or more data objects in the archive of encrypted data objects; and
comparing the decrypted portion of the encrypted data object and the decrypted portion of the or more data objects in the archive of encrypted data objects.

3. The method of claim 1, wherein the encrypted data object and the one or more data objects in the archive of encrypted data objects are encrypted using a homomorphic encryption algorithm.

4. The method of claim 1, wherein comparing the encrypted data object and the similar data object comprises comparing at least one of the following parameters:
a) a file name;
b) a file size;
c) a version;
d) a configuration; or
e) metadata associated with a creation date and/or last modification date.

5. The method of claim 1, wherein the archived unique information comprises one or more of the following:
a) at least one file or a portion thereof;
b) at least one registry entry; and/or
c) data associated with a user-defined or preset configuration.

6. The method of claim 1, wherein the encrypted data object comprises one or more of the following:
a) an application;
b) a database;
c) at least one file or a portion thereof; and/or
d) an operating system component.

7. The method of claim 1, wherein comparing the encrypted data object and the similar data object is performed by a client application executed on the remote computing node and the unique information is transmitted by the client application to the data center.

8. The method of claim 1, wherein the archived reference to the copy of the encrypted data object or the similar data object is a symbolic link or a hard link.

9. The method of claim 1, wherein the encrypted data object is not decrypted at any point during the archiving process.

10. The method of claim 1, wherein comparing the encrypted data object and the similar data object comprises performing a binary-level comparison.

11. The method of claim 1, wherein the encrypted data object comprises an application and the similar data object comprises a different version of the application.

12. The method of claim 1, wherein the archived unique information comprises at least one file, or a portion thereof, unique to the encrypted data object and omitted from the similar data object.

13. The method of claim 1, wherein the reference to the similar data object comprises a hard link or a symbolic link.

14. A system for archiving electronic data, comprising:
an electronic memory; and
a processor configured to:
receive, by a data center, a request to archive an encrypted data object stored on a remote computing node;
determine, by the data center, whether at least one of a copy of the encrypted data object or a similar data object exists in an archive of encrypted data objects stored at the data center;
when a copy of the encrypted data object is found, generate a reference to the copy of the encrypted data object and archive the reference as a proxy for the encrypted data object;
when a similar data object is found,
generate a reference to the similar data object;
identify information unique to the encrypted data object by comparing the encrypted data object and the similar data object; and
archive the reference to the similar data object and the unique information as a proxy for the encrypted data object.

15. The system of claim 14, wherein the processor is further configured to perform any of the methods disclosed herein.

16. A non-transitory computer readable medium storing computer executable instructions for archiving electronic data, including instructions for:
receiving, by a data center, a request to archive an encrypted data object stored on a remote computing node;
determining, by the data center, whether at least one of a copy of the encrypted data object or a similar data object exists in an archive of encrypted data objects stored at the data center;
when a copy of the encrypted data object is found, generating a reference to the copy of the encrypted data object and archiving the reference as a proxy for the encrypted data object; when a similar data object is found,
generating a reference to the similar data object;
identifying information unique to the encrypted data object by comparing the encrypted data object and the similar data object; and
archiving the reference to the similar data object and the unique information as a proxy for the encrypted data object.

17. The medium of claim 16, wherein determining whether the at least one of a copy of the encrypted data object or a similar data object exists comprises:
decrypting, at least a portion of the encrypted data object;
decrypting, at least a portion of the one or more data objects in the archive of encrypted data objects; and
comparing the decrypted portion of the encrypted data object and the decrypted portion of the or more data objects in the archive of encrypted data objects.

18. The medium of claim 16, wherein the encrypted data object and the one or more data objects in the archive of encrypted data objects are encrypted using a homomorphic encryption algorithm.

19. The medium of claim 16, wherein comparing the encrypted data object and the similar data object comprises comparing at least one of the following parameters:
a file name;
a file size;
a version;
a configuration; or
metadata associated with a creation date and/or last modification date.

20. The medium of claim 1, wherein the archived unique information comprises one or more of the following:
at least one file or a portion thereof;
at least one registry entry; and/or
data associated with a user-defined or preset configuration.
